(19) United States
(12) Patent Application Publication
(10) Pub. No.: US 2025/0158381 A1
(43) Pub. Date: May 15, 2025

(54) PROTECTION RELAY SYSTEM

(71) Applicant: LS ELECTRIC CO., LTD., Anyang-si, Gyeonggi-do (KR)

(72) Inventor: Sungjin JANG, Anyang-si, Gyeonggi-do (KR)

(21) Appl. No.: 18/836,091

(22) PCT Filed: Mar. 17, 2023
(86) PCT No.: PCT/KR2023/003565

§ 371 Date: Aug. 6, 2024

(30) Foreign Application Priority Data
Apr. 6, 2022 (KR) 10-2022-0042958

(51) Int. Cl. H02H 1/00; H04B 3/58

(52) U.S. Cl. CPC H02H 1/0007; H04B 3/58

(57) ABSTRACT

The present specification relates to a protection relay system in which a relay device transmits data to a repeater device, the repeater device transmits the data to a terminal device, and the repeater device repeats communication between the relay device and the terminal device.

### TECHNICAL FIELD

Embodiments of this specification relate to a protection relay system that protects a grid.

### BACKGROUND ART

The technology behind the present disclosure relates to a protection relay system that protects equipment in a grid.

An intelligent electronic device (IED), which is a device that protects equipment in an electrical grid, is a digital electronic apparatus mainly provided with a function of sending or receiving monitoring, control, measurement, protection, and interlock functions of pieces of equipment within a substation to or from the outside through communication. In the protection and distribution panel industry, the device is collectively referred to as an intelligent electronic device (IED). The intelligent electronic device (IED) receives and senses voltage and current signals, and outputs a signal to turn off a circuit breaker when an abnormality occurs in an electrical grid. Furthermore, a human machine interface (HMI) terminal is mounted on a front surface portion of the main body to allow a user to check or set the status information and data of the IED.

FIG. 1 shows a configuration of a conventional protection relay system mounted with an HMI in an IED.

As shown in FIG. 1, in the related art, an HMI 20 is located on a front surface portion of an IED body 10, and a data communication interface C between the HMI 20 and the IED body 10 is configured to transmit and receive data therebetween through in a physically directly connected manner.

The HMI 20 in such a conventional IED may display information on an HMI screen using only data that is provided by a single IED body 10, and also has a limitation in that it can only transmit control commands that can be accepted by the IED body 10 to the single IED body 10. In addition, in this method, when data configuration used in the IED body 10 changes, there is an inconvenience in that data communication must be reconfigured according to the changed data configuration in the HMI 20. Moreover, when the data communication interface C in the IED body 10 changes, there is a disadvantage in that hardware configuration must be changed according to the changed data communication interface C in the HMI 20.

### DISCLOSURE OF INVENTION

### Technical Problem

An aspect of the present disclosure is to improve the limitations of the related art as described above.

That is, an aspect of the present disclosure is to improve the limitations caused by a direct data communication method between a relay device and a terminal device in a protection relay system.

Accordingly, an aspect of this specification is to provide an embodiment of a protection relay system in which a change in communication and system configuration can be easily made due to a change such as addition or exclusion of a device.

In addition, an aspect of the present disclosure is to provide an embodiment of a protection relay system that can conveniently and easily utilize a plurality of relay devices and terminal devices.

Moreover, an aspect of the present disclosure is to provide an embodiment of a protection relay system that can conveniently and easily operate the system.

### Solution to Problem

In an embodiment of this specification for solving the foregoing problems, communication may be performed between a relay device and a terminal device through a communication repeater device.

Specifically, the relay device may transmit data to the repeater device, and the repeater device may transmit data to the terminal device such that the repeater device repeats communication between the relay device and the terminal device.

That is, in the present disclosure, communication between a relay device and a terminal device may be repeated through a repeater device, thereby solving the problems.

The above technical features may be applied to a system including one or more relay devices and a terminal device that displays operation information of the one or more relay devices, and this specification employs the above technical features as a solution means to provide an embodiment of a protection relay system that can be applied to the foregoing system.

According to an embodiment having the technical features as a solution means, there is provided a protection relay system that protects equipment in a grid, the protection relay system including one or more relay devices provided in the grid to monitor the status of the grid and generate first data for operation information including the monitoring result, a repeater device that receives the first data from the one or more relay devices and generates second data corresponding to the first data, and a terminal device that receives the second data from the repeater device and displays the operation information on a screen based on the second data.

In one embodiment, the one or more relay devices may generate the first data in a first format that can be received by the repeater device, and the repeater device may generate the second data through processing the first data into a second format that can be received by the terminal device.

In one embodiment, the first data and the second data may be data in different formats.

In one embodiment, the first data and the second data may be data in the same format.

In one embodiment, the one or more relay devices may communicate with the repeater device in a first communication method, and the terminal device may communicate with the repeater device in a second communication method different from the first communication method.

In addition, according to another embodiment having the technical features as a solution means, there is provided a protection relay system that protects equipment in a grid, the protection relay system including a plurality of relay devices each provided in the grid to monitor the status of the grid and generate first data for operation information including the monitoring result, a repeater device that receives the first data from each of the plurality of relay devices and generates second data each corresponding to the first data, and a terminal device that receives each of the second data from the repeater device, collects the second data to generate third data, and displays the operation information on a screen based on the third data.

In one embodiment, the plurality of relay devices may each generate the first data in a first format that can be transmitted to the repeater device, and the repeater device may generate the second data through processing the first data into a second format that can be transmitted to the terminal device.

In one embodiment, the first format and the second format may be different formats.

In one embodiment, the first format and the second format may be the same format.

In one embodiment, the repeater device may communicate with the plurality of relay devices in a first communication method, and communicate with the terminal device in a second communication method different from the first communication method.

In addition, according to still another embodiment having the technical features as a solution means, there is provided a protection relay system that protects equipment in a grid, the protection relay system including a plurality of relay devices each provided in the grid to monitor the status of the grid and generate first data for operation information including the monitoring result, a repeater device that receives the first data from each of the plurality of relay devices, generates second data each corresponding to the first data, and collects the second data to generate third data, and a terminal device that receives the third data from the repeater device and displays the operation information on a screen based on the third data.

In one embodiment, the plurality of relay devices may each generate the first data in a first format that can be transmitted to the repeater device, and the repeater device may generate the second data through processing the first data into a second format that can be transmitted to the terminal device.

In one embodiment, the first format and the second format may be different formats.

In one embodiment, the first format and the second format may be the same format.

In one embodiment, the repeater device may communicate with the plurality of relay devices in a first communication method, and communicate with the terminal device in a second communication method different from the first communication method.

### Advantageous Effects of Invention

According to an embodiment of a protection relay system of the present disclosure, a relay device may transmit data to a repeater device, the repeater device may transmit data to a terminal device such that the repeater device repeats communication between the relay device and the terminal device, thereby having an effect of facilitating a change in communication and system configuration due to a change such as addition or exclusion of a device.

Accordingly, there is an effect of conveniently and easily utilizing a plurality of relay devices and terminal devices, as well as conveniently and easily operating the system.

In addition, there is an effect of allowing various utilizations of data using a repeater device and an appropriate grid operation based thereon.

Moreover, there is an effect of increasing the stability and reliability of the protection relay system.

As a result, in an embodiment of the protection relay system of the present disclosure, there is an effect of solving the limitations of the related art, as well as improving a communication environment of the protection relay system.

The effects of the embodiment are not limited to the above-mentioned effects, and other effects that are not mentioned herein will be clearly understood by those skilled in the art from the following detailed description and appended claims.

### BRIEF DESCRIPTION OF DRAWINGS

FIG. 1 is a configuration diagram of a protection relay system in a related art.

FIG. 2 is a configuration diagram of a protection relay system according to an embodiment.

FIG. 3 is a specific configuration diagram of the protection relay system shown in FIG. 2.

FIG. 4 is a specific exemplary diagram 1 of a protection relay system according to an embodiment.

FIG. 5 is a specific exemplary diagram 2 of a protection relay system according to an embodiment.

FIG. 6 is a specific exemplary diagram 3 of a protection relay system according to an embodiment.

### MODE FOR THE INVENTION

Hereinafter, an embodiment of a protection relay system disclosed herein will be described in detail with reference to the accompanying drawings, and the same or similar elements are designated with the same numeral references regardless of the numerals in the drawings and their redundant description will be omitted.

Furthermore, in describing technologies disclosed herein, the detailed description will be omitted when a specific description for publicly known technologies disclosed herein is judged to obscure the gist of the present disclosure or when easily understood or inferred by those skilled in the art without any specific description. Also, it should be noted that the accompanying drawings are merely illustrated to easily explain the concept of the technology disclosed in this specification, and therefore, they should not be construed to limit the concept of the technology by the accompanying drawings.

A configuration of a protection relay system (hereinafter referred to as a relay system) according to an embodiment is shown as in FIG. 2.

The relay system 1000 according to an embodiment, which is a protection relay system that protects equipment in a grid, as shown in FIG. 2, includes one or more relay devices 100 provided in the grid to monitor the status of the grid and generate first data for operation information including the monitoring result, a repeater device 200 that receives the first data from the one or more relay devices 100 and generates second data corresponding to the first data, and a terminal device 300 that receives the second data from the repeater device 200 and displays the operation information on a screen based on the second data.

Here, the relay device 100 may be an intelligent electronic device (IED), and the terminal device 300 may be a human machine interface (HMI) terminal.

In the relay system 1000, the one or more relay devices 100 may communicate (C1) with the repeater device 200 to transmit the first data to the repeater device 200, and the terminal device 300 may communicate (C2) with the repeater device 200 to receive the second data corresponding to the first data transmitted from the one or more relay devices 100 to the repeater device 200.

That is, in the relay system 1000, the repeater device 200 performs communication (C1) with the one or more relay devices 100 and communication (C2) with the terminal device 300 to transmit and receive data so as to repeat communication (C1 and C2) between the one or more relay devices 100 and the terminal device 300.

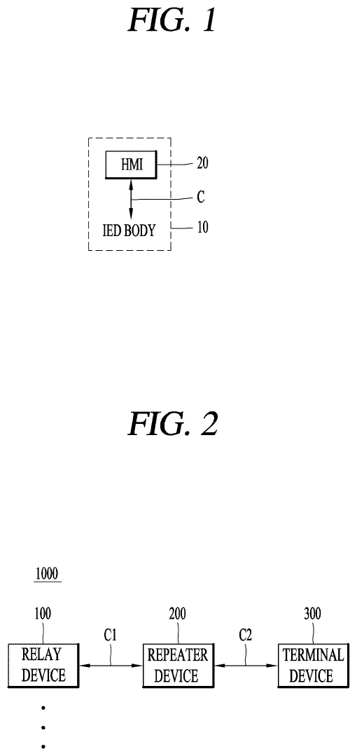

As described above, in the relay system 1000, the repeater device 200 repeats communication between the relay device 100 and the terminal device 300, and thus, instead of using a method of communicating, by the conventional single IED 10, through a data communication interface C that is physically directly connected to the HMI 20 as shown in FIG. 1, the system is configured such that the single IED 10 transmits data through a specific data repeater device, and the HMI 20 also exchange data with the single IED 10 through the data repeater device.

Accordingly, the HMI 20 is not dependent on the single IED 10, but is allowed to communicate with one or more IEDs 10 connected to the data repeater device, that is, allowed to perform communication through the single HMI 20 in a 1:1 or 1:N connection, thereby making it possible to operate and utilize various systems using data from the one or more IEDs 10.

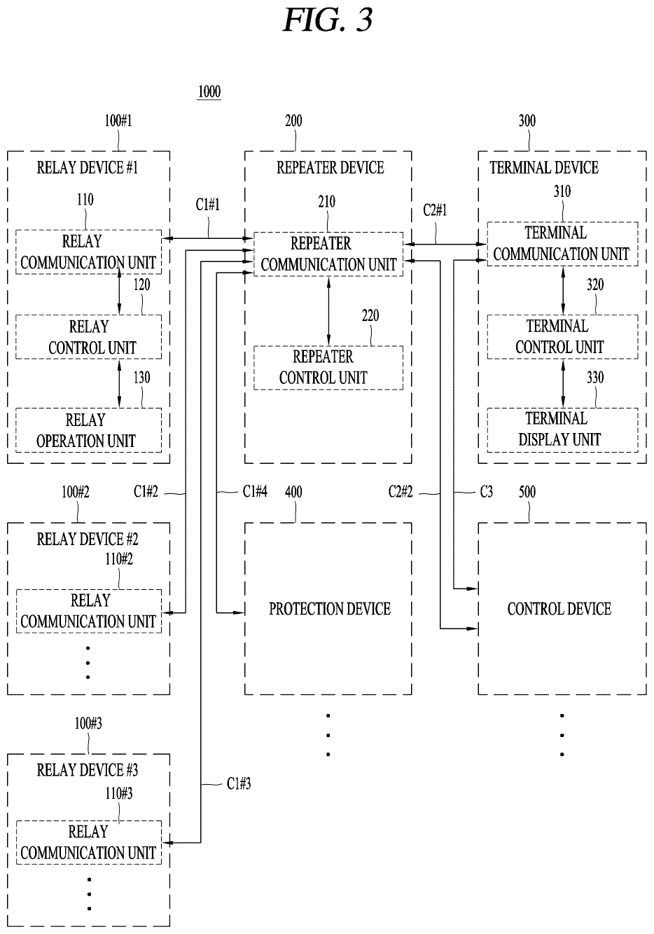

A specific configuration of the relay system 1000 according to this embodiment may be as shown in FIG. 3.

In the relay system 1000, there may be one or more relay devices 100, preferably, in plurality 100 #1, 100 #2, 100 #3.

In this case, each of the plurality of relay devices 100 #1, 100 #2, 100 #3 may communicate (C1) with the repeater device 200.

Although in the example of FIG. 3 it is shown that there are provided three relay devices 100, there may be provided two or four or more relay devices 100.

The relay device 100 may include a relay communication unit 110 that communicates with the repeater device 200 to transmit and receive data, a relay control unit 120 that controls an overall operation of the relay device 100, including execution of communication of the relay communication unit 110, and a relay operation unit 130 that performs a relay operation of the relay device 100.

The relay communication unit 110 may perform communication with the repeater device 200 under the control of the relay control unit 120 to transmit the first data to the repeater device 200.

The relay communication unit 110 may also receive data from the repeater device 200.

The relay control unit 120 may control the communication of the relay communication unit 110 to monitor the status of the grid through the relay operation unit 120 at a location where the relay device 100 is provided, generate the first data for operation information including the monitoring result, and transmit the first data to the repeater device 200 through the relay communication unit 110.

The relay control unit 120 may also control the relay operation unit 130 according to the monitoring result to control the execution of a protection operation for the grid.

The relay operation unit 130 may detect one or more of the voltage, current, and power of the grid at a location where the relay device 100 is provided, and operates a relay under the control of the relay control unit 120 to perform a protection operation for the grid.

When the relay device 100 is provided in plurality, each of the plurality of relay devices 100 #1, 100 #2, 100 #3 may communicate (C1 #1, C1 #2, C1 #3) with the repeater device 200 through the relay communication unit 110 #1, 110 #2, 110 #3 to transmit each first data to the repeater device 200.

In the relay system 1000, the repeater device 200 may include a repeater communication unit 210 that communicates with the one or more relay devices 100 and the terminal device 300 to transmit and receive data, and a repeater control unit 220 that controls an overall operation of the repeater device 200, including execution of communication of the repeater communication unit 210.

The repeater communication unit 210 may perform communication with the one or more relay devices 100 and the terminal device 300 under the control of the repeater control unit 220 to receive the first data from the one or more relay devices 100 and transmit the second data corresponding to the first data to the terminal device 300.

The repeater communication unit 210 may also perform communication with a protection device 400 other than the one or more relay devices 100 provided in the grid under the control of the repeater control unit 220 to receive data from the protection device 400 and transmit the received data to the terminal device 300.

The repeater communication unit 210 may also receive data from the terminal device 300.

The repeater communication unit 210 may also transmit data received from the terminal device 300 to the one or more relay devices 100, or transmit data generated by the repeater control unit 220 to the one or more relay devices 100.

The repeater control unit 220 may control the repeater communication unit 210 to receive the first data from the one or more relay devices 100 through the repeater communication unit 210, generate the second data corresponding to the first data, and transmit the second data to the terminal device 300 through the communication unit 210.

In the relay system 1000, the terminal device 300 may include a terminal communication unit 310 that communicates with the repeater device 200 to transmit and receive data, a terminal control unit 320 that controls an overall operation of the terminal device 300, including execution of communication of the terminal communication unit 310, and a terminal display unit 330 that displays the operation information on a screen based on the second data.

The terminal communication unit 310 may perform communication with the repeater device 200 under the control of the terminal control unit 320 to receive the second data from the repeater device 200.

The terminal communication unit 310 may also perform communication with a control device 500 that controls the grid under the control of the terminal control unit 320 to receive data from the control device 500.

The terminal communication unit 310 may also transmit data generated by the terminal control unit 320 to the repeater device 200.

The terminal control unit 320 may receive the second data from the repeater device 200 through the terminal communication unit 310 to control the communication of the terminal communication unit 310 and the display of the terminal display unit 330 so as to display the operation information on the terminal display unit 330 based on the second data.

The terminal display unit 330 may display the operation information under the control of the terminal control unit 320.

In the relay system 1000 as described above, the one or more relay devices 100 may generate the first data in a first format that can be received by the repeater device 200, and the repeater device 200 may generate the second data through processing the first data in a second format that can be received by the terminal device 300.

Here, the processing may refer to converting the first data, equalizing or filtering the first data.

That is, the repeater device 200 may receive the first data from the one or more relay devices 100, and transmit the second data obtained by processing the first data into a format that can be received by the terminal device 300 to the terminal device 300.

Accordingly, the repeater device 200 may receive the first data in the first format, process it into the second format, and then transmit the second data to the terminal device 300.

The first data and the second data may be data in different formats.

That is, the first format and the second format may be different formats.

Accordingly, the first data generated by the one or more relay devices 100 may be in a format that is different from that of the second data received by the terminal device 300.

In this case, the repeater device 200 may convert the first data into the second format that is different from the first format, and transmit the second data corresponding to the conversion result to the terminal device 300.

The first data and the second data may also be data in the same format.

That is, the first format and the second format may also be the same format.

In this case, the repeater device 200 may equalize or filter the first data, and transmit the second data corresponding to the equalizing or filtering result to the terminal device 300.

The one or more relay devices 100 may communicate with the repeater device 200 in a first communication method, and the terminal device 300 may communicate with the repeater device 200 in a second communication method different from the first communication method.

In this case, the repeater device 200 may repeat communication between the one or more relay devices 100 and the terminal device 300 that communicate with each other in different methods.

Additionally, the one or more relay devices 100 and the terminal device 300 may communicate with the repeater device 200 in the same communication method.

Meanwhile, in the relay system 1000, the relay device 100 may be provided in plurality, and a relay function of the repeater device 200 may be implemented in another embodiment.

In another embodiment of the relay system 1000, the relay device 100 #n is provided in plurality, wherein each of the plurality of relay devices 100 #n is provided in the grid to monitor the status of the grid to generate first data for operation information including the monitoring result, the repeater device 200 receives the first data from each of the plurality of relay devices 100 #n to generate second data each corresponding to the first data, and the terminal device 300 receives each of the second data from the repeater device 200, collects the second data to generate third data, and displays the operation information on a screen based the third data.

That is, when each of the plurality of relay devices 100 #n transmits the first data to the repeater device 200, the repeater device 200 may process the first data into the second data that can be received by the terminal device 300 and then transmit the processed second data to the terminal device 300, and the terminal device 300 may receive and then collect the second data, and display operation information on each of the plurality of relay devices 100 #n on a screen based on the third data obtained by collecting the second data.

Accordingly, the terminal device 300 may receive and collect the second data from the repeater device 200, and display the operation information on a screen based on the collected data.

Additionally, in another embodiment of the relay system 1000, the relay device 100 #n is provided in plurality, wherein each of the plurality of relay devices 100 #n is provided in the grid to monitor the status of the grid to generate first data for operation information including the monitoring result, the repeater device 200 receives the first data from each of the plurality of relay devices 100 #n to generate second data each corresponding to the first data, and collects the second data to generate third data, and the terminal device 300 receives the third data from the repeater device 200 to display the operation information on a screen based the third data.

That is, when each of the plurality of relay devices 100 #n transmits the first data to the repeater device 200, the repeater device 200 may process the first data into the second data that can be received by the terminal device 300 and then collect the processed second data, and transmit the third data obtained by collecting the second data to the terminal device 300.

Accordingly, the terminal device 300 may receive the collected data from the repeater device 200, and display the operation information on a screen based on the collected data.

In the relay system 1000, each of the plurality of relay devices 100 #n may generate the first data in a first format that can be transmitted to the repeater device 200, and the repeater device 200 may generate the second data through processing the first data in a second format that can be transmitted to the terminal device 300.

Here, the first format and the second format may be different formats.

The first format and the second format may also be the same format.

The repeater device 200 may communicate with the plurality of relay devices 100 #n in a first communication method, and communicate with the terminal device 300 in a second communication method different from the first communication method.

Additionally, the repeater device 200 may communicate with the one or more relay devices 100 and the terminal device 300 in the same communication method.

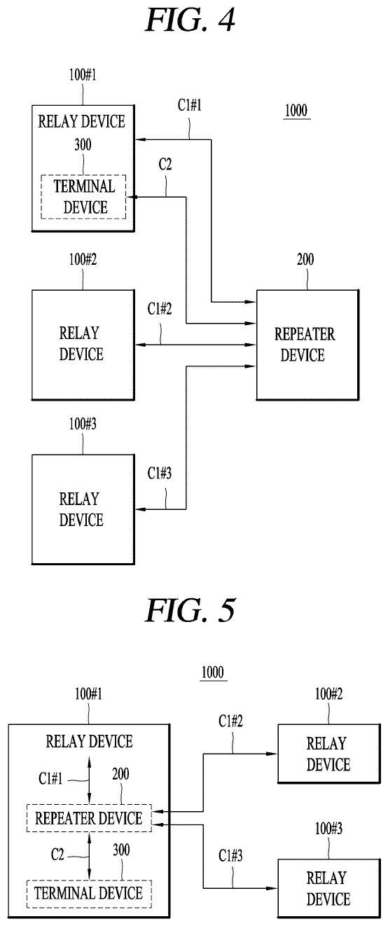

Meanwhile, when the relay device 100 is provided in plurality, the system may be implemented in one of the forms shown in FIGS. 4 to 6.

When the relay device 100 is provided in plurality, in the protection relay system 1000, the terminal device 300 may be mounted on any one of a plurality of relay devices 100 #n as shown in FIG. 4.

In addition, as shown in FIG. 5, the repeater device 200 and the terminal device 300 may be mounted on any one of a plurality of relay devices 100 #n.

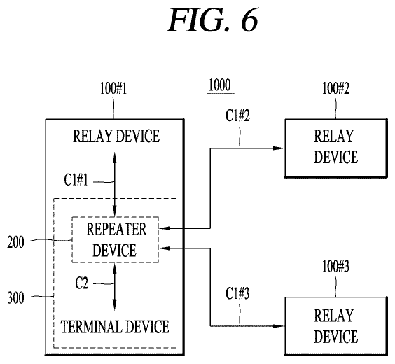

In addition, as shown in FIG. 6, the repeater device 200 may be built into the terminal device 300, and the terminal device 300 may be mounted on any one of a plurality of relay devices 100 #n.

For instance, the terminal device 300 may be mounted on a relay device 100 #1 provided at a location that can be operated by a user among the plurality of relay devices 100 #n.

In the protection relay system 1000 according to the foregoing embodiment, in a case where an existing IED requires an HMI, even though a method of embedding an HMI for each of individual IEDs in terms of hardware is not applied thereto, a common HMI may be utilized to perform data display, data management, and control functions through the HMI in the individual IEDs.

In addition, the common HMI may collect and manage the data of individual IEDs through a data repeater device, thereby performing a protection cooperation operation between the IEDs in the units of HMIs.

Additionally, there is no need to embed individual HMI hardware for each of individual IEDs so as to lower the product price and lower the complexity of the system, thereby reducing failures and increasing system stability.

The foregoing preferred embodiments of the present disclosure are disclosed to solve technical problems, and it will be apparent to those skilled in this art that various modifications, variations and additions can be made thereto without departing from the spirit and scope of the present disclosure, and those modifications and the like should be construed to be included in the following claims.

[Description of Reference numerals]

| | |
|---|---|
| 100: Relay device | 200: Repeater device |
| 300: Terminal device | 1000: Protection relay system |

1. A protection relay system that protects equipment in a grid, the protection relay system comprising:
one or more relay devices provided in the grid to monitor the status of the grid and generate first data for operation information including the monitoring result;
a repeater device that receives the first data from the one or more relay devices and generates second data corresponding to the first data; and
a terminal device that receives the second data from the repeater device and displays the operation information on a screen based on the second data.

2. The protection relay system of claim 1, wherein the one or more relay devices generate the first data in a first format that can be received by the repeater device, and
wherein the repeater device generates the second data through processing the first data into a second format that can be received by the terminal device.

3. The protection relay system of claim 2, wherein the first data and the second data are data in different formats.

4. The protection relay system of claim 2, wherein the first data and the second data are data in the same format.

5. The protection relay system of claim 1, wherein the one or more relay devices communicate with the repeater device in a first communication method, and
wherein the terminal device communicates with the repeater device in a second communication method different from the first communication method.

6. A protection relay system that protects equipment in a grid, the protection relay system comprising:
a plurality of relay devices each provided in the grid to monitor the status of the grid and generate first data for operation information including the monitoring result;
a repeater device that receives the first data from each of the plurality of relay devices and generates second data each corresponding to the first data; and
a terminal device that receives each of the second data from the repeater device, collects the second data to generate third data, and displays the operation information on a screen based on the third data.

7. The protection relay system of claim 6, wherein the plurality of relay devices each generate the first data in a first format that can be transmitted to the repeater device, and
wherein the repeater device generates the second data through processing the first data into a second format that can be transmitted to the terminal device.

8. The protection relay system of claim 7, wherein the first format and the second format are different formats.

9. The protection relay system of claim 7, wherein the first format and the second format are the same format.

10. The protection relay system of claim 6, wherein the repeater device communicates with the plurality of relay devices in a first communication method, and communicates with the terminal device in a second communication method different from the first communication method.

11. A protection relay system that protects equipment in a grid, the protection relay system comprising:
a plurality of relay devices each provided in the grid to monitor the status of the grid and generate first data for operation information including the monitoring result;
a repeater device that receives the first data from each of the plurality of relay devices, generates second data each corresponding to the first data, and collects the second data to generate third data; and
a terminal device that receives the third data from the repeater device and displays the operation information on a screen based on the third data.

12. The protection relay system of claim 11, wherein the plurality of relay devices each generate the first data in a first format that can be transmitted to the repeater device, and
wherein the repeater device generates the second data through processing the first data into a second format that can be transmitted to the terminal device.

13. The protection relay system of claim 12, wherein the first format and the second format are different formats.

14. The protection relay system of claim 12, wherein the first format and the second format are the same format.

15. The protection relay system of claim 14, wherein the repeater device communicates with the plurality of relay devices in a first communication method, and communicates with the terminal device in a second communication method different from the first communication method.
